(19) United States
(12) Patent Application Publication
(10) Pub. No.: US 2014/0027573 A1
(43) Pub. Date: Jan. 30, 2014

(54) AIRCRAFT FUSELAGE STRUCTURAL ELEMENT WITH VARIABLE CROSS-SECTION

(71) Applicant: AIRBUS OPERATIONS (S.A.S), Toulouse (FR)

(72) Inventors: Hélène CAZENEUVE, Fontenilles (FR); Fabrice MONTEILLET, Toulouse (FR); Yann MARCHIPONT, Launaguet (FR)

(73) Assignee: AIRBUS OPERATIONS (S.A.S), Toulouse (FR)

(21) Appl. No.: 13/953,419

(22) Filed: Jul. 29, 2013

(30) Foreign Application Priority Data
Jul. 30, 2012 (FR) 1257347

(51) Int. Cl. B64C 1/06

(52) U.S. Cl. CPC B64C 1/061
USPC 244/119

(57) ABSTRACT

An aircraft fuselage structural element has the general form of an elongated profile and includes a web and at least one flange. The at least one flange has a curved cross-section tangent to the web. Use in a profile to increase the residual compressive strength after impact.

### CROSS REFERENCE TO RELATED APPLICATION

This application is entitled to and claims the benefit of French Application No. 1257347 filed Jul. 30, 2012, the disclosure of which, including the specification, claims, drawings and abstract, are incorporated herein by reference in their entirety.

### FIELD

The invention relates to an aircraft fuselage structural frame element.

### BACKGROUND

Generally, aircraft fuselage structures are made up of a skin to which, among other things, elements are fixed, including structural elements known as stiffeners or frames.

Generally, such structural elements take the form of a profile extending along a curve defined by a series of radii of curvature, so that they follow the specific curvature of the fuselage skin.

The cross-section of said profiles, which is substantially constant, is usually L-, U- or Z-shaped, or other more or less complex shapes that always comprise at least one web and one or two flanges located at one and/or both ends of the web.

When they are made from metal materials (aluminium or titanium alloys), the frames are produced using extruded profiles, then shaped by plastic deformation, for example by drawing or rolling.

These production methods, which are particularly cost-effective, are however only applicable on profiles with a constant cross-section over their entire length.

To reduce the mass of the fuselage, it is desirable that the dimensions of the cross-section be as small as possible apart from at certain points where the stresses exerted are locally significant.

To this end, it is known to produce an intermediate product by extrusion and plastic forming, with a larger cross-section and/or thickness than the final part, and then to machine said product by stock removal so as to locally adjust the cross-section and thickness thereof.

Alternatively, it is also known to obtain the structural element by stock removal from a thicker plate.

These methods of obtaining profiles are however much less cost-effective, as they require that a large amount of material be reduced to swarf.

In order to reduce the mass of fuselages even further, it is also known to replace metal materials with fibre-reinforced composite materials.

The profiles are thus obtained in particular from fibres stacked in defined orientations and according to a defined stacking sequence.

An example of such a profile is described in FR 2 970 743.

Said profile is produced by placing several layers of dry fibres with a defined orientation (plies) in a mould with the shape of the cross-section and curvature of the part. The fibres are then impregnated with resin by resin transfer or infusion.

For curved profiles such as fuselage frames, such a production method requires making fibres with no capacity for plastic deformation, which must not wrinkle or undulate as this will be detrimental to the mechanical properties of the product obtained, follow a curved cross-section.

This operation is carried out by hand and requires a certain dexterity on the part of the operator, therefore resulting in high production costs.

Alternatively, the profiles can be produced from pre-impregnated fibres deposited on the mould by fibre placement.

Such an operation consists of performing three-dimensional draping of narrow strips, for example using a robot fitted with a fibre placement head.

For aviation applications, the fibres are constituted by carbon, and the matrix, of a thermosetting resin.

Usually, profiles made using this production method are dimensioned in the light of the predominant criterion of damage tolerance, in other words the residual mechanical strength after impact.

This is normally due to the fact that the almost flat geometry of the flange in the extension direction of the profile facilitates the local buckling of said profile, thus propagating the delamination of the laminate after impact and resulting in damage thereto.

Given the above, there is therefore a need to produce aircraft fuselage structural elements having a reduced weight and a high residual compressive strength after impact.

### SUMMARY

To this end, the invention relates to an aircraft fuselage structural frame element in the general form of an elongated profile comprising a web and at least one flange having an arc-shaped cross-section over the length of the profile apart from on at least one end portion of the profile, in which said cross-section varies so as to have a straight cross-section perpendicular to said web.

The geometry of the flange defined by a curved shape tangent to the web makes it possible to reduce the local buckling of the structural element, and thus decreases the propagation of the delamination of the laminate after impact.

The variation in the cross-section of the flange from a curved geometry to a flat geometry makes it possible to retain optimum bulk and mass in the connection zones between the structural elements at the connecting ends.

The structural frame element thus has a web that is locally sufficiently high to withstand the hammering and fatigue stresses at the connection points between elements.

Given the considerable size of commercial passenger aircraft fuselages, a frame is made up of several structural elements forming sectors of the circumference of the fuselage.

Said elements are assembled by fishplating, that is, by means of battens fixed to the frame using rivets.

Such connections must comprise enough fasteners to transfer the mechanical load that they bear from one part to another.

Thus, in addition to the criterion of damage tolerance, as the materials chosen are not capable of plastic deformation, the resistance to hammering stresses (stress flow transfer between the surfaces of two parts in contact in the assembly zones during impacts) also comes into play.

Finally, so that the fasteners withstand fatigue and hammering, rules regarding the spacing thereof must be followed.

In order to install the number of fasteners capable of taking up the various loads at the connections while following the spacing rules relating to said fasteners, the web of the profile must be sufficiently high (i.e. sufficiently long in the plane of the cross-section of the profile).

However, said height must not be too great, otherwise the mass of the structure will increase and the volume available inside the fuselage for the commercial payload and the installation of the systems will be reduced.

The straight cross-section perpendicular to the web at the connecting end thus makes it possible to achieve the best compromise, which consists of increasing the height of the web as much as possible while minimising the total height of the profile, i.e. minimising the radii of curvature between the flange(s) and the web.

In practice, the structural frame element comprises two connecting ends, said cross-section varying along the profile in such a way as to have, at the two connecting ends, a straight cross-section perpendicular to said web.

According to a feature, the profile has a constant height along the profile, the height of the web portion in the curved cross-section of the profile being smaller than the height of the web portion in the straight cross-section perpendicular to the web.

To strengthen the structural element at certain points subject to the greatest stresses, the thickness of the element can vary along the profile.

The height of the structural frame element can also vary along the profile.

In order to fit the local curvature of the fuselage, the profile extends over a fixed or variable radius of curvature.

So as to lighten the structural frame element, it is made from a continuous fibre-reinforced composite material.

Said fibres are for example carbon fibres, thus ensuring great mechanical strength vis-à-vis the macroscopic or primary deformation modes of the fuselage.

The invention also relates to a set of structural frame elements as described above, which are assembled together by respective connecting ends, the curved cross-section of one or both of the flanges of the profile of the structural elements varying along the profile in such a way as to have, at said respective connecting ends, a straight cross-section perpendicular to the web.

This makes it possible to install the number of fasteners suitable for taking up the various loads at the connections while following the spacing rules relating to said fasteners.

The invention also relates to an aircraft comprising a structural frame element as briefly mentioned above.

### BRIEF DESCRIPTION OF DRAWINGS

Further features and advantages will become apparent during the following description, given as a non-limitative example with reference to the attached drawings, in which:

FIG. 1 is a diagrammatic perspective representation of an embodiment of a portion of a structural element with a flange having an arc-shaped cross-section with a constant radius;

FIG. 2 is a diagrammatic perspective representation of an end portion of a structural element, showing the transition between a flange with an arc-shaped cross-section and a flange with a straight cross-section;

FIG. 3 is a diagrammatic perspective representation of the end portion in FIG. 2 from another angle;

FIG. 4 is a diagrammatic cross-sectional representation of the element in FIG. 2 along the line IV-IV; and

FIG. 5 is a diagrammatic cross-sectional representation of the element in FIG. 2 along the line V-V.

In the remainder of the document, by cross-section is meant a cross-section transverse to the profile, normal to the local longitudinal direction in which it extends.

### DETAILED DESCRIPTION OF EMBODIMENTS

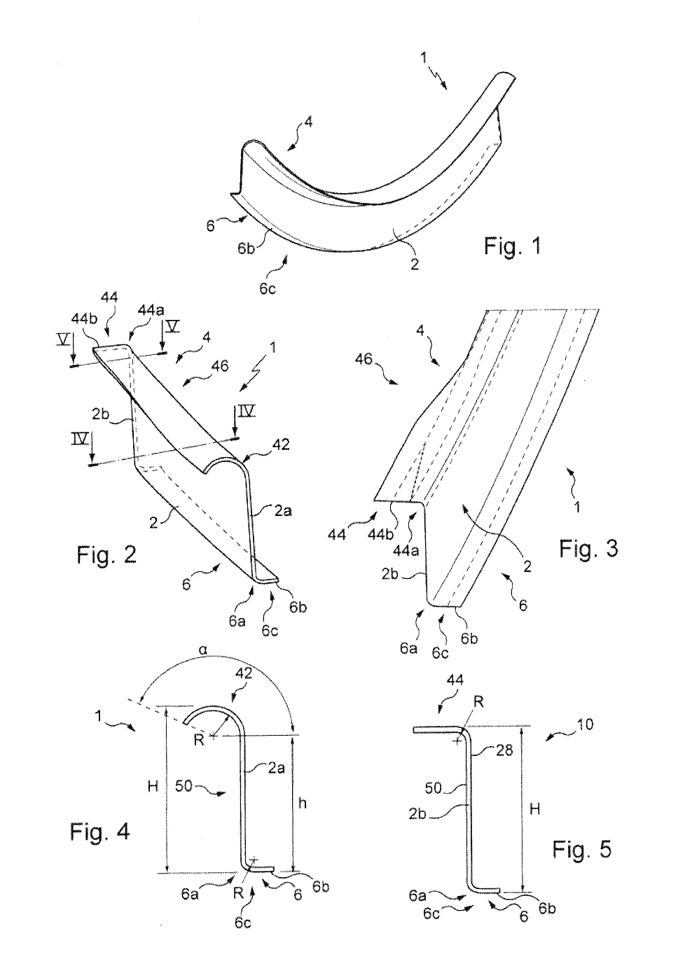

The aircraft fuselage structural element 1 partially shown in FIGS. 1, 2 and 3, also known as the frame, has the general form of an elongated profile, extending locally in a longitudinal direction,

As shown in FIG. 1, said profile extends along a curve so that the structural element 1 can follow the shape of a fuselage (not shown) to which it is to be fastened. Said curve may have a fixed or variable radius.

In a preferred embodiment, said element 1 is made from a continuous fibre-reinforced composite material, for example produced by placement of pre-impregnated fibres on a mould.

More particularly, for an aviation application, the fibres are carbon fibres.

The structural element 1 comprises a straight web 2, here extended on either side of its height (length in the plane of the cross-section of the structural element) by an upper flange 4 and a lower flange 6 respectively, the shape of which will be described in detail below.

In the context of the incorporation of the structural element into the fuselage of a conventionally-shaped aircraft, the upper flange 4 corresponds to the flange located towards the inside of the fuselage.

Conversely, the lower flange 6 corresponds to the flange located towards the outside of the fuselage, i.e. the flange closest to the fuselage.

Said lower flange 6 has a straight cross-section, perpendicular to the web 2 and with a constant geometry all along the structural element 1.

It will be noted that in the particular embodiments shown in FIGS. 1 to 5, the structural element 1 does not have a straight edge, and therefore the transition from the web 2 to the lower flange 6 has a curvature 6a.

An edge replacing the curvature 6a can however be envisaged in other embodiments.

The lower flange 6 is extended, from the curvature 6a, by a straight lower extension 6b that that thus forms the “foot” of the frame.

As shown in FIG. 1, the upper flange 4 has a curved cross-section, and here an arc-shaped cross-section.

In the portion of the structural element illustrated in FIG. 1, corresponding for example to a central portion of a structural element, the upper flange 4 thus has a double-curve geometry.

Thus, the upper flange 4 has a constant radius of curvature in its transverse cross-section, thus forming an arc.

Furthermore, said upper flange 4 follows the curvature of the profile in its longitudinal direction.

However, a straight profile or even a profile with several curved zones as a function of the shape of the fuselage skin can be envisaged in other embodiments.

Near a connecting end of the structural element, the cross-section of the upper flange 4 varies along the structural element 1.

As can be seen in FIGS. 2 and 4, in a portion 42 of the structural element 1, the upper flange 4 has a curved cross-section, and here an arc-shaped cross-section.

In this portion 42 of the structural element 1, the cross-section of the profile is therefore J-shaped.

The cross-section of the upper flange 4 then varies gradually, from said portion 42, from an arc-shaped cross-section to a straight cross-section, located at a connecting end 44.

At this connecting end 44 of the structural element 1, the cross-section of the profile is therefore Z-shaped.

It will be noted that for the assembly of a set of structural elements, each structural element preferably comprises two connecting ends 44 to connect structural elements to each other.

Thus, at each end portion 46 of the structural element 1, the geometry of the flange 4 passes through a succession of curved shapes with different radii of curvature to vary in this end portion 46 from a J shape to a Z shape, and vice versa.

The connecting end 44 of the upper flange 4, which can be seen in more detail in FIGS. 3 and 5, therefore has a straight cross-section perpendicular to the web 2.

Again, as the structural element 1 does not have a straight edge in the present embodiment, the transition from the web 2 to the connecting end 44 of the upper flange has a curvature 44a.

An edge replacing the curvature 44a can however be envisaged in other embodiments.

The upper flange 4 is extended, from the curvature 44a, by a straight upper extension 44b.

As can be seen in FIGS. 4 and 5 in particular, the upper flange 4 extends from the web 2 in the opposite direction to the lower flange 6.

However, in other embodiments than those shown in FIGS. 1 to 5, particularly one in which the structural element is a profile with a C-shaped cross-section, the upper flange 4 can extend in the same direction as the lower flange 6 from the web 2.

In addition, it can also be envisaged that said two flanges 4, 6 are the same length, or of different lengths.

The advantages of the variation in the cross-section of the upper flange 4 in the end portion 46 of the structural element 1 will now be described with reference to FIGS. 4 and 5.

The portion 42 has an arc-shaped cross-section with a radius R extending over a sector α.

This makes it possible in particular to make the upper flange 4 locally more impact resistant, due to its radius allowing for a reduction in local buckling.

More particularly, the structural element 1 preferably being made from fibre-reinforced composite materials, such a reduction in buckling decreases the propagation of the delamination of the laminate.

The value of the radius R and the sector α will be chosen in particular in such a way as to obtain the desired damage tolerance (residual mechanical strength after impact) and mass of the structural element 1.

Said mass also depends on the height H of the structural element 1.

It will be noted to this end that in said portion 42 of the structural element 1, the web portion 2a has a height h smaller than the height H of the structural element 1.

Generally, the larger the radius of curvature R of the curved shape of the cross-section of the upper flange 4, the smaller the height h of the web portion 2a when the height H of the structural element 1 is constant.

Preferably, said portion 42 of the structural element 1 with a curved cross-section extends over the majority of the profile, with only the end portions 46 having a cross-section that varies in such a way as to have a straight cross-section perpendicular to the web 2 at the connecting ends 44.

At the connecting end 44 of the structural element 1, the cross-section is straight and perpendicular to the web 2b.

The main advantage of this configuration lies in the fact that the height of the web portion 2b is substantially the height H of the structural element 1. It is therefore as large as possible for a fixed bulk, i.e. a constant height H of the profile.

Said highest web portion 2b makes it possible to install the number of fasteners suitable for taking up the loads at the connection, while following any spacing rules relating to said fasteners.

In the embodiment shown in the figures, the structural element 1 has a constant thickness and height H.

However, in other embodiments, the height and/or thickness of the web 2 of the profile can conversely vary locally along the profile in such a way as to adjust to local geometric or dimensioning criteria, or to local stresses or forces, to make it possible to install more equipment, etc.

The examples described above are merely possible, non-limitative embodiments of the invention.

It will be noted that in the examples described above, the aircraft fuselage structural element has at least one profile flange with a curved cross-section that varies so that at the two ends of the profile it has a straight cross-section perpendicular to the web.

It will be noted that, optionally, the structural element can retain an elongated profile having a web and a flange with a curved cross-section tangent to the web, at one of the connecting ends of the structural element or at both connecting ends of the structural element.

1. Aircraft fuselage structural frame element, having the general form of an elongated profile, comprising a web (2) and at least one flange (4, 6), characterized in that said at least one flange (4) has an arc-shaped cross-section over the length of the profile apart from on at least one end portion (46) of the profile in which said cross-section varies so as to have a straight cross-section perpendicular to said web (2).

2. Structural frame element according to claim 1, characterized in that it comprises two connecting ends (44), said curved cross-section varying along the profile in such a way as to have, at the two connecting ends (44), a straight cross-section perpendicular to said web (2).

3. Structural frame element according to claim 1, characterized in that the profile has a constant height (H) along the profile, the height (h) of the web portion (2a) in the curved cross-section of the profile being smaller than the height (H) of the web portion (2b) in the straight cross-section perpendicular to the web (2).

4. Structural frame element according to claim 1, characterized in that the height (H) of the structural element (1) varies along the profile.

5. Structural frame element according to claim 1, characterized in that the thickness of the structural element (1) varies along the profile.

6. Structural frame element according to claim 1, characterized in that the elongated profile extends over a fixed or variable radius of curvature.

7. Structural frame element according to claim 1, characterized in that it is made from a continuous fibre-reinforced composite material.

8. Set of structural frame elements according to claim 1, characterized in that said structural elements (1) are assembled together by respective connecting ends (44), the curved cross-section of one or both of the flanges of the profile of the structural elements varying along the profile in such a way as to have, at said respective connecting ends (44), a straight cross-section perpendicular to the web (2).

9. Aircraft comprising a set of aircraft fuselage structural frame elements (1) according to claim 8
